(19) United States
(12) Patent Application Publication
(10) Pub. No.: US 2019/0225470 A1
(43) Pub. Date: Jul. 25, 2019

(54) MANAGEMENT DEVICE, MANAGEMENT METHOD AND PROGRAM

(71) Applicant: NEC Corporation, Tokyo (JP)

(72) Inventors: Jun UCHIMURA, Tokyo (JP); Hideaki TAKAHASHI, Tokyo (JP)

(73) Assignee: NEC Corporation, Tokyo (JP)

(21) Appl. No.: 16/336,349

(22) PCT Filed: Sep. 5, 2017
(86) PCT No.: PCT/JP2017/031954

§ 371 Date: Mar. 25, 2019

(30) Foreign Application Priority Data
Sep. 29, 2016 (JP) 2016-191006

(51) Int. Cl. B66F 9/24; G06K 7/10; B66F 17/00; G01S 11/06

(52) U.S. Cl. CPC B66F 9/24; G01S 11/06; B66F 17/003; G06K 7/10

(57) ABSTRACT

A management device includes a reception strength acquirer that acquires reception strengths of transmission signals transmitted by a plurality of transmission devices attached respectively to management targets when the transmission signals are received by a plurality of reading devices, and a degradation determinator that determines, on the basis of a result of comparison between an index value based on a plurality of reception strengths acquired in a predetermined period and a newly acquired reception strength, whether or not one of the plurality of reading devices that has received a transmission signal corresponding to the newly acquired reception strength has degraded.

### TECHNICAL FIELD

The present invention relates to a management device, a management method and a program.

### BACKGROUND ART

In recent years, transmission devices such as integrated circuit (IC) tags are attached to various management targets. A transmission device transmits a signal which includes an identification (ID) uniquely identifying the transmission device. A reading device that has received the signal transmitted by the transmission device acquires information such as a location and the like of a management target to which the transmission device is attached by receiving the signal and detecting the ID. It is possible to manage the management target by using the information of the location and the like.

In the case in which transmission devices are attached respectively to a large number of management targets, a large number of reading devices that read signals transmitted from the transmission devices are needed. The accuracy of reception of transmission signals by a reading device may degrade and thus there is a demand for a device capable of easily determining the degradation. Patent Documents 1 to 3 have been disclosed as related technologies.

### CITATION LIST

### Patent Literature

### [Patent Document 1]

Japanese Unexamined Patent Application, First Publication No. 2007-199938

### [Patent Document 2]

Japanese Unexamined Patent Application, First Publication No. 2008-019046

### [Patent Document 3]

Japanese Unexamined Patent Application, First Publication No. 2007-128505

### SUMMARY OF INVENTION

### Technical Problem

An object of the present invention is to provide a management device, a management method and a program which solve the above problems.

### Solution to Problem

According to a first aspect of the present invention, a management device includes a reception strength acquirer configured to acquire reception strengths of transmission signals transmitted by a plurality of transmission devices attached respectively to management targets when the transmission signals are received by a plurality of reading devices; and a degradation determinator configured to determine, on the basis of a result of comparison between an index value based on a plurality of reception strengths acquired in a predetermined period and a newly acquired reception strength, whether or not one of the plurality of reading devices that has received a transmission signal corresponding to the newly acquired reception strength has degraded.

According to a second aspect of the present invention, a reading device management method includes acquiring reception strengths of transmission signals transmitted by a plurality of transmission devices attached respectively to management targets when the transmission signals are received by a plurality of reading devices; and determining, on the basis of a result of comparison between an index value based on a plurality of reception strengths acquired in a predetermined period and a newly acquired reception strength, whether or not one of the plurality of reading devices that has received a transmission signal corresponding to the newly acquired reception strength has degraded.

According to a third aspect of the present invention, a program causes a computer for a management device to function as a reception strength acquisition means that acquires reception strengths of transmission signals transmitted by a plurality of transmission devices attached respectively to management targets when the transmission signals are received by a plurality of reading devices; and a degradation determination means that determines, on the basis of a result of comparison between an index value based on a plurality of reception strengths acquired in a predetermined period and a newly acquired reception strength, whether or not one of the plurality of reading devices that has received a transmission signal corresponding to the newly acquired reception strength has degraded.

### Advantageous Effects of Invention

According to the present invention, it is possible to easily determine degradation of a number of reading devices that an administrator uses to read signals transmitted from a number of transmission devices.

### BRIEF DESCRIPTION OF DRAWINGS

FIG. 1 is a diagram showing a relationship between a forklift and a container according to an embodiment.

FIG. 2 is a first diagram showing an example of a carry-in source or a carry-out destination according to an embodiment.

FIG. 3 is a second diagram showing an example of a carry-in source or a carry-out destination according to an embodiment.

FIG. 4 is a third diagram showing an example of a carry-in source or a carry-out destination according to an embodiment.

FIG. 5 is a diagram showing a hardware configuration of a work management device according to a first embodiment.

FIG. 6 is a diagram showing a hardware configuration of a center-side management device according to the first embodiment.

FIG. 7 is a functional block diagram of the work management device and the center-side management device according to the first embodiment.

FIG. 8 is a diagram showing a first exemplary operation of a forklift according to the first embodiment.

FIG. 9 is a diagram showing a second exemplary operation of a forklift according to the first embodiment.

FIG. 10 is a first diagram showing a process flow for the center-side management device according to the first embodiment.

FIG. 11 is a diagram showing a minimal configuration of the management device.

### DESCRIPTION OF EMBODIMENTS

Hereinafter, a management device, a management method and a program according to an embodiment of the present invention will be described with reference to the drawings.

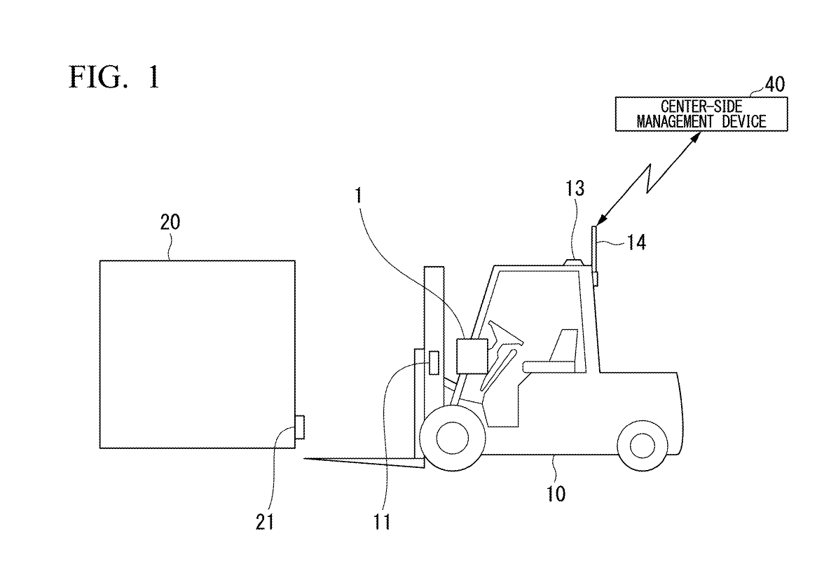

FIG. 1 is a diagram showing a relationship between a forklift 10 and a container 20.

In FIG. 1, the forklift 10 is an example of a cargo handling machine. The container 20 is an example of a management target. The forklift 10 includes a work management device 1, an antenna 11 (a reading device), a satellite positioning antenna 13, a communication antenna 14, and the like. A detailed configuration of the forklift 10 will be omitted since it is known. An IC tag 21 (a transmission device) is attached to the container 20. An insertion hole for inserting a fork (cargo gripping mechanism) of the forklift 10 is formed in the container 20. The IC tag 21 is attached, for example, near this insertion hole. The driver advances the forklift 10 and inserts the fork into the insertion hole to load the container 20 on the forklift. At this time, the IC tag 21 and the antenna 11 approach each other.

The satellite positioning antenna 13 receives a signal from an artificial satellite. The work management device 1 acquires information included in the signal that the satellite positioning antenna 13 has received from the artificial satellite. The work management device 1 detects the position of the forklift 10 on the basis of the information included in the signal.

The work management device 1 communicates with other devices such as the center-side management device 40 that manages the forklift 10 or the container 20 through the communication antenna 14. The communication antenna 14 is connected to the work management device 1 through a communication cable.

The work management device 1 manages work on a management target such as the container 20. The work management device 1 acquires a reception strength of a transmission signal transmitted from the IC tag 21 at the time when the transmission signal is received by the antenna 11. The antenna 11 may measure the reception strength or alternatively the work management device 1 may measure the reception strength on the basis of information corresponding to the transmission signal that the work management device 1 has acquired from the antenna 11. The work management device 1 compares the acquired reception strength with an index value and determines whether or not the antenna 11 (a reading device), which has received the transmission signal corresponding to the acquired reception strength, has degraded on the basis of the comparison result. The index value is based on the reception strengths of transmission signals transmitted by IC tags 21 attached to a plurality of containers 20 acquired in a predetermined period.

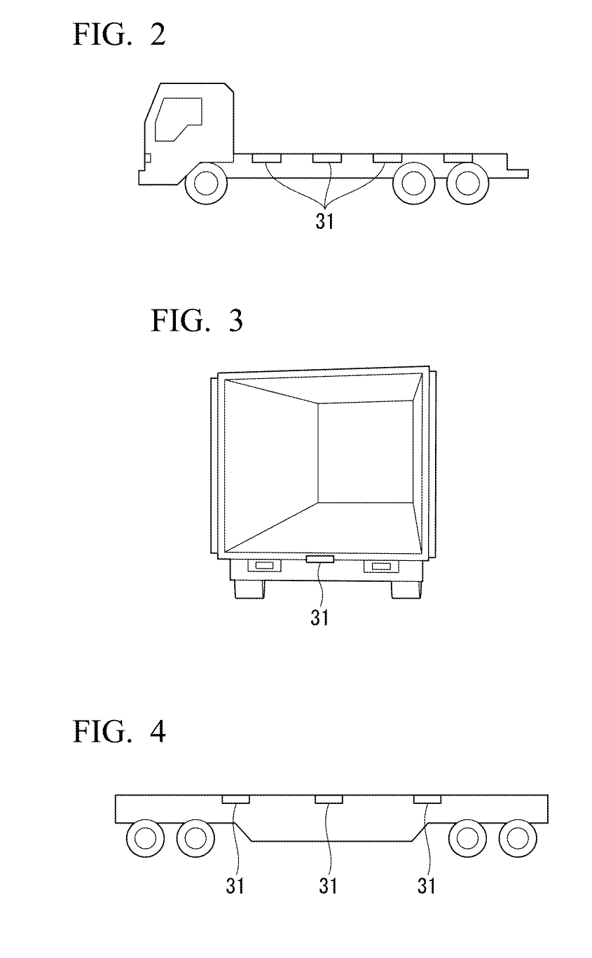

FIG. 2 is a first diagram showing an example of a carry-in source or a carry-out destination.

FIG. 2 shows a first truck as a carry-in source or a carry-out destination of a management target. Placement position tags 31 (a transmission device) that transmit transmission signals including a placement position ID are attached to the first truck. The first truck has no box-shaped cover provided on a cargo bed. In this case, the forklift 10 can load the container 20 on the cargo bed from the side of the cargo bed. Alternatively, the forklift 10 can perform work of loading the container 20 on the fork from the side of the cargo bed to carry the container 20 out to another transport destination. The work management device 1 can also acquire the reception strengths of transmission signals transmitted from the placement position tags 31 when the forklift 10 performs a work of placing the container 20 on the first truck or a work of carrying the container 20 out of the first truck.

FIG. 3 is a second diagram showing an example of a carry-in source or a carry-out destination.

FIG. 3 shows a second truck as a carry-in source or a carry-out destination. A placement position tag 31 that transmits a transmission signal including a placement position ID is also attached to the second truck. The second truck has a box-shaped cover provided on a cargo bed. In this case, the forklift 10 can load the container 20 on the cargo bed from the rear of the truck in response to the driver's operation, for example, with a rear door of the box-shaped cover on the cargo bed being opened. Alternatively, the forklift 10 can perform a work of loading the container 20 on the fork from the rear of the truck to carry the container 20 out to another transport destination. The work management device 1 can also acquire the reception strength of a transmission signal transmitted from the placement position tag 31 when the forklift 10 performs a work of placing the container 20 on the second truck or a work of carrying the container 20 out of the second truck.

FIG. 4 is a third diagram showing an example of a carry-in source or a carry-out destination.

FIG. 4 shows a freight car as a carry-in source or a carry-out destination. Placement position tags 31 that transmit transmission signals including a placement position ID are also attached to the freight car. In this case, the forklift 10 can load the container 20 on the cargo bed from the side of the freight car. Alternatively, the forklift 10 can perform a work of loading the container 20 on the fork from the side of the freight car to carry the container 20 out to another transport destination. The work management device 1 can also acquire the reception strengths of transmission signals transmitted from the placement position tags 31 when the forklift 10 performs a work of placing the container 20 in the freight car or a work of carrying the container 20 out of the freight car.

### First Embodiment

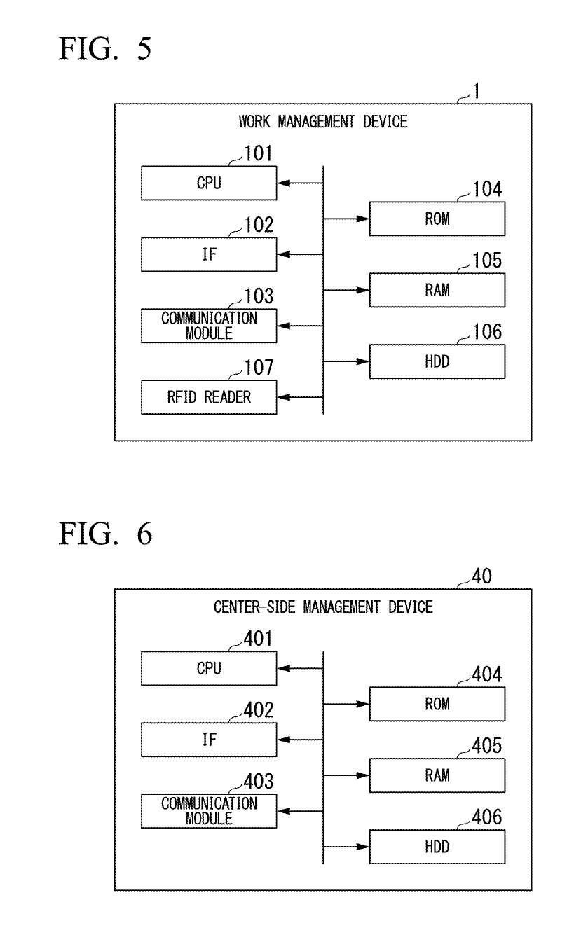

FIG. 5 is a diagram showing a hardware configuration of a work management device 1 according to a first embodiment.

As shown in FIG. 5, the work management device 1 includes components such as a central processing unit (CPU) 101, an interface (IF) 102, a communication module 103, a read only memory (ROM) 104, a random access memory (RAM) 105, a hard disk drive (HDD) 106, a radio frequency identification (RFID) reader 107 (a reading device), and the like. The communication module 103 transmits and receives signals via the communication antenna 14. The RFID reader 107 performs a process of reading a transmission signal according to reception of the transmission signal by the antenna 11. The IF 102 is connected, for example, to an input/output device such as a touch panel display provided on the work management device 1 and inputs information to and outputs information from the input/output device.

FIG. 6 is a diagram showing a hardware configuration of a center-side management device 40 according to the first embodiment.

As shown in FIG. 6, the center-side management device 40 includes components such as a central processing unit (CPU) 401, an interface (IF) 402, a communication module 403, a read only memory (ROM) 404, a random access memory (RAM) 405, a hard disk drive (HDD) 406, and the like.

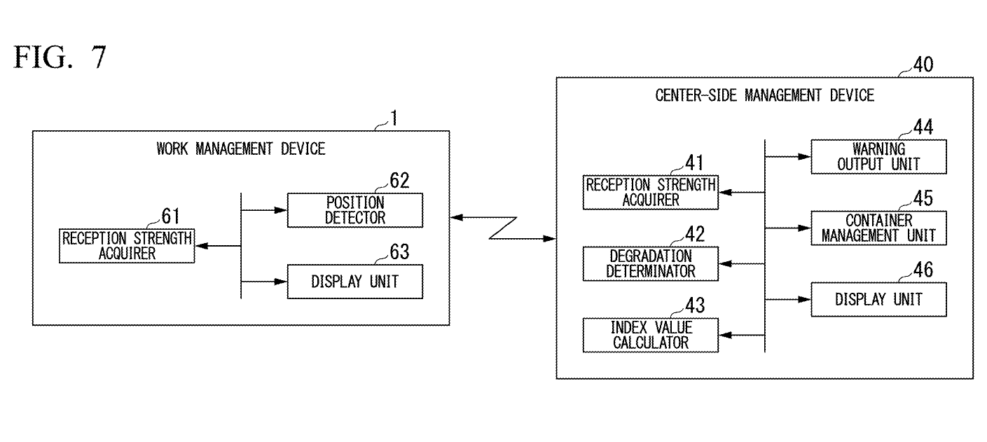

FIG. 7 is a functional block diagram of the work management device 1 and the center-side management device 40.

The CPU 101 executes a work management program stored in advance, thereby allowing the work management device 1 to have the functions of a reception strength acquirer 61, a position detector 62 and a display unit 63.

The CPU 401 executes a center-side management program stored in advance, thereby allowing the center-side management device 40 to have the functions of a reception strength acquirer 41, a degradation determinator 42, an index value calculator 43, a warning output unit 44, a container management unit 45 and a display unit 46.

In the work management device 1, the reception strength acquirer 61 acquires a reception strength of a transmission signal (a management target identification signal) transmitted from the IC tag 21 or a transmission signal (a placement position identification signal) transmitted from the placement position tag 31 at the time when the transmission signals are received by the antenna 11. The reception strength acquirer 61 transmits the acquired reception strength to the center-side management device 40. The reception strength acquirer 61 may acquire the maximum reception strength among a plurality of reception strengths of transmission signals obtained in a single occurrence of approach of the antenna 11 and the IC tag 21 or the placement position tag 31.

The position detector 62 detects the position of the forklift 10.

The display unit 63 outputs various information to a monitor connected to the work management device 1.

In the center-side management device 40, the reception strength acquirer 41 acquires, from the work management device 1, the reception strength of a transmission signal received by the work management device 1 and an ID of a tag that has transmitted the transmission signal.

The degradation determinator 42 compares the index value calculated by the index value calculator 43 with the newly acquired reception strength. On the basis of the comparison result, the degradation determinator 42 determines whether or not the antenna 11 (the reading device) which has received the transmission signal of the acquired reception strength has degraded. In the case in which the work management device 1 calculates the reception strength of the transmission signal, the degradation determinator 42 may determine whether or not the reception strength calculation function of the work management device 1 has degraded.

The index value calculator 43 calculates an index value serving as a reference for performing degradation determination of the antenna 11. Specifically, the index value calculator 43 acquires the highest reception strength for each IC tag 21 or each placement position tag 31 in a predetermined period among reception strengths greater than or equal to a threshold value serving as a reference for performing degradation determination of the antenna 11 and calculates an index value on the basis of the acquired highest reception strength. The index value may be an average value or the like of reception strengths acquired in a predetermined period. Alternatively, the index value calculator 43 may calculate, as an index value, an average value of reception strengths greater than or equal to a predetermined threshold value among a plurality of reception strengths acquired in a predetermined period. The index value may be calculated using any method as long as whether or not the reception strength has degraded can be determined from the calculated index value.

The warning output unit 44 outputs warning information when the degradation determinator 42 determines that the IC tag 21 or the placement position tag 31 has degraded.

The container management unit 45 manages cargo handling work of the container 20 on the basis of information or the like received from the work management device 1.

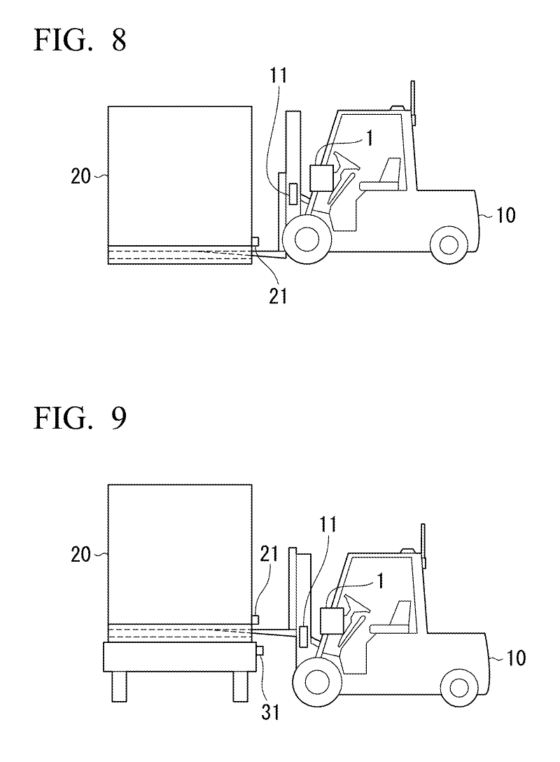

FIG. 8 is a diagram showing a first exemplary operation of the forklift 10.

FIG. 8 shows an exemplary operation of the forklift 10 when the forklift 10 loads the container 20 placed on a site such as a container yard, which is the carry-in source, on the forklift 10 itself in response to the driver's operation. In this case, the IC tag 21 and the antenna 11 approach each other. When the IC tag 21 and the antenna 11 approach each other, the reception strength acquirer 61 acquires a reception strength of a transmission signal transmitted from the IC tag 21 and transmits the acquired reception strength to the center-side management device 40. The degradation determinator 42 of the center-side management device 40 determines whether or not the antenna 11 has degraded on the basis of the newly acquired reception strength.

FIG. 9 is a diagram showing a second exemplary operation of the forklift 10.

FIG. 9 shows an exemplary operation of the forklift 10 when the forklift 10 places the container 20 on a carry-out destination or loads the container 20 on the forklift 10 itself from a carry-in source in response to the driver's operation. In this case, the placement position tag 31 and the antenna 11 approach each other. When the placement position tag 31 and the antenna 11 approach each other, the reception strength acquirer 61 acquires a reception strength of a transmission signal transmitted from the placement position tag 31 and transmits the acquired reception strength to the center-side management device 40. The degradation determinator 42 of the center-side management device 40 determines degradation of the antenna 11 on the basis of the newly acquired reception strength.

The index value calculator 43 of the center-side management device 40 acquires the reception strengths of transmission signals transmitted from a plurality of different IC tags 21 and placement position tags 31 in a predetermined period from a plurality of different work management devices 1. The predetermined period may be, for example, several months from the start of using a manufactured IC tag 21. The index value calculator 43 calculates an index value on the basis of the acquired reception strengths. The calculation of the index value based on the reception strengths of transmission signals from the plurality of different IC tags 21 and placement position tags 31 may be according to the premise that the IC tags 21 and the placement position tags 31 are the same type of tag devices of the same manufacturer. Alternatively, the calculation may be according to the premise that the IC tags 21 and the placement position tags 31 are manufactured according to the same standard and the transmission strengths of transmission signals are the same. Similarly, the calculation may be according to the premise that the antenna 11 and the work management device 1 are manufactured by the same manufacturer or according to the same standard. Under such a premise, the center-side management device 40 can calculate the index value in an environment in which transmission or reception environments of transmission signals are unified.

The index value calculator 43 calculates an average value of reception strengths obtained when transmission signals transmitted from a plurality of different IC tags 21 and placement position tags 31 are received by different antennas 11 in a predetermined period. The index value calculator 43 stores the calculated average value as an index value. The index value calculator 43 may also specify the highest reception strength among reception strengths greater than or equal to a threshold value serving as a reference for performing the degradation determination, for each IC tag 21 or each placement position tag 31 and for each antenna 11 or each work management device 1 of which the reception strength has been calculated, and calculate an average value of the specified reception strengths as an index value. Thus, it is possible to calculate an index value at the time when it is assumed that the IC tag 21 or the placement position tag 31 and the antenna 11 are closest to each other. Alternatively, the index value calculator 43 may calculate, as an index value, an average value of reception strengths greater than or equal to a predetermined threshold value among a plurality of reception strengths acquired in a predetermined period.

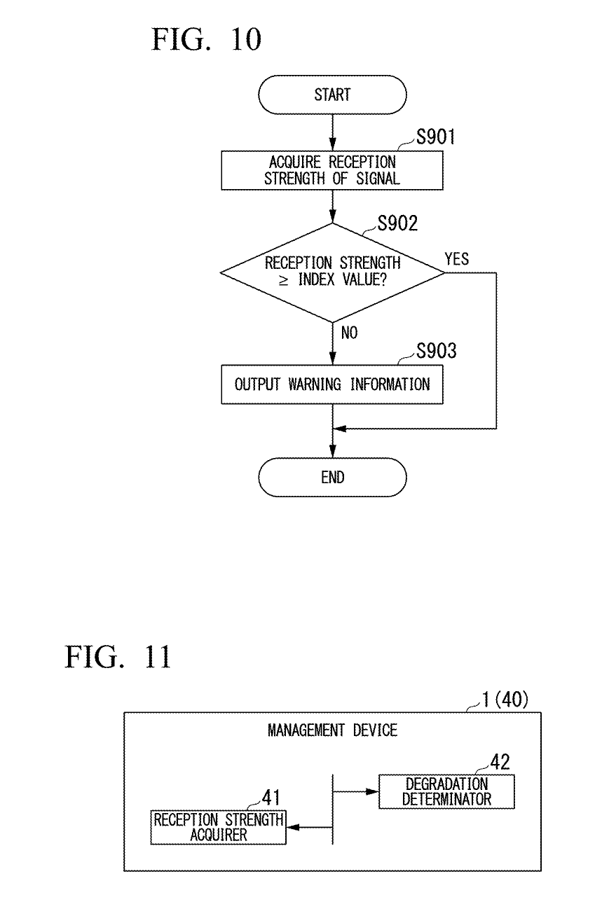

FIG. 10 is a first diagram showing a process flow for the center-side management device 40 according to the first embodiment.

The reception strength acquirer 41 acquires reception strength information including the reception strength of a transmission signal received by the antenna 11 from each of different work management devices 1 (step S901). The reception strength information may include the ID of an IC tag 21 or a placement position tag 31 that has transmitted the transmission signal, the ID of the work management device 1, the ID of the antenna 11, the ID of the forklift 10, or the like. The reception strength acquirer 41 outputs the reception strength information to the degradation determinator 42. The degradation determinator 42 reads the index value calculated by the index value calculator 43 from a storage unit or the like. The degradation determinator 42 compares the reception strength included in the reception strength information with the index value (step S902). When the acquired reception strength is lower than the index value, the degradation determinator 42 outputs information indicating degradation of the antenna 11 to the warning output unit 44. When the acquired reception strength is greater than or equal to the index value, the degradation determinator 42 ends the process. When information indicating degradation is input to the warning output unit 44 from the degradation determinator 42, the warning output unit 44 outputs warning information (step S903). The warning output unit 44 may output the warning information to the display unit 46 or output sound through a speaker or the like. On the basis of the ID of the work management device 1 or the like included in the reception strength information, the degradation determinator 42 of the center-side management device 40 may transmit a result of the degradation determination to the work management device 1 identified by the ID. Upon receiving the result of the degradation determination, the work management device 1 outputs warning information to notify the driver of the forklift 10. The degradation determinator 42 may determine that the antenna 11 has degraded when the newly acquired reception strength is lower than the index value by a predetermined value or more. The predetermined value may be determined on the basis of the index value. For example, the predetermined value may be a half of the index value, the index value multiplied by a predetermined ratio, or the like.

It is to be noted that the function of the degradation determinator 42 described above may be provided in the work management device 1. In this case, the center-side management device 40 transmits the index value calculated by the index value calculator 43 to the work management device 1. Thus, the degradation determinator and the warning output unit of the work management device 1 may perform the processing of step S902 and step S903 in the same manner.

The above is a description of the first embodiment of the present invention. According to the process described above, the center-side management device 40 or the work management device 1 can determine degradation of the antenna 11 that receives transmission signals transmitted from the IC tags 21 and the placement position tags 31 while the forklift 10 performs cargo handling work. Further, the center-side management device 40 or the work management device 1 can determine degradation of the reception function (reception strength calculation function) of the work management device 1. The center-side management device 40 or the work management device 1 can easily determine degradation of a number of reading devices such as antennas 11 or work management devices 1 that an administrator uses to read signals transmitted from a number of transmission devices such as IC tags 21 or the like.

The first embodiment is an example in which degradation determination is performed using an index value calculated from the reception strengths of transmission signals of a plurality of different transmission devices when the transmission signals thereof are read by a plurality of different antennas 11. On the basis of comparison between a newly acquired reception strength and an index value based on the reception strengths of a plurality of transmission signals that each of a plurality of IC tags 21 and placement position tags 31 has transmitted in a predetermined period and that have been read by a plurality of different antennas 11, the degradation determinator 42 determines degradation of an antenna 11 that has received a transmission signal of the newly acquired reception strength or the like.

### Second Embodiment

In a second embodiment, degradation determination is performed using an index value calculated from the reception strengths of a transmission signal of one IC tag 21 or placement position tag 31 when the transmission signal thereof is received by antennas 11 of a plurality of different forklifts 10. In the second embodiment, on the basis of comparison between a newly acquired reception strength and an index value based on the reception strengths of a plurality of transmission signals that one IC tag 21 or the like has transmitted in a predetermined period and that have been read by a plurality of antennas 11, the degradation determinator 42 determines degradation of an antenna 11 or the like which has received a transmission signal of the newly acquired reception strength. That is, the index value calculator 43 calculates an index value for each of IC tags 21 and placement position tags 31 on the basis of a plurality of reception strengths acquired in a predetermined period. The degradation determinator 42 identifies an IC tag 21 or a placement position tag 31 corresponding to a transmission signal of a newly acquired reception strength and acquires an index value corresponding to the identified tag from the index value calculator 43. The degradation determinator 42 compares the acquired index value with the newly acquired reception strength and determines whether or not the antenna 11 or the like has degraded on the basis of the comparison result. By using an index value for each of IC tags 21 and placement position tags 31, it is possible to determine degradation of the antenna 11 or the like in consideration of the individual difference between IC tags 21 and placement position tags 31.

### Third Embodiment

In a third embodiment, degradation determination is performed using an index value calculated from the reception strengths of transmission signals of a plurality of different IC tags 21 and placement position tags 31 when the transmission signals thereof are read by an antenna 11 of one forklift 10. In the third embodiment, on the basis of comparison between a newly acquired reception strength and an index value based on the reception strengths of a plurality of transmission signals that each of a plurality of IC tags 21 or placement position tags 31 has transmitted in a predetermined period and that have been read by one antenna 11, the degradation determinator 42 determines degradation of the antenna 11 or the like which has received a transmission signal of the newly acquired reception strength. That is, the index value calculator 43 calculates an index value for each antenna 11 on the basis of a plurality of reception strengths acquired in a predetermined period. The degradation determinator 42 identifies an antenna 11 corresponding to a transmission signal of a newly acquired reception strength and acquires an index value corresponding to the identified antenna 11 from the index value calculator 43. The degradation determinator 42 compares the acquired index value with the newly acquired reception strength and determines whether or not the antenna 11 or the like has degraded on the basis of the comparison result. By using an index value for each antenna 11, it is possible to determine degradation of the antenna 11 or the like in consideration of the individual difference between antennas 11.

FIG. 11 is a diagram showing a minimal configuration of a management device.

As shown in FIG. 11, the management device (the work management device 1 or the center-side management device 40) includes at least a reception strength acquirer 41 and a degradation determinator 42.

The above description has been given with reference to an example in which management targets are containers 20 and the management device is provided in the work management device 1 of the forklift 10 or in the center-side management device 40. However, management targets may be other objects (for example, over-the-counter items such as storefront items of clothing or books). In this case, the management device may be included in a portable terminal.

The work management device or the center-side management device 40 described above has a computer system therein. The procedures of the above processes are stored in a computer-readable recording medium in the form of a program, and the above processes are performed by a computer reading and executing the program. Here, the “computer-readable recording medium” refers to a magnetic disk, a magneto-optical disk, a CD-ROM, a DVD-ROM, a semiconductor memory, or the like. The computer program may also be delivered to a computer via a communication line, and the computer which has received the program may execute the program.

Further, the program may be one for realizing some of the above-described functions. The program may also be a so-called differential file (differential program) which can realize the above-described functions in combination with a program already recorded in the computer system.

Priority is claimed on Japanese Patent Application No. 2016-191006, filed Sep. 29, 2016, the content of which is incorporated herein by reference.

### INDUSTRIAL APPLICABILITY

The present invention can be applied to applications requiring easy determination of degradation of a number of reading devices that an administrator uses to read signals transmitted from a number of transmission devices.

### REFERENCE SIGNS LIST

1 Work management device

10 Forklift

11 Antenna

13 Satellite positioning antenna

14 Communication antenna

20 Container

21 IC tag

31 Placement position tag

40 Center-side management device

41, 61 Reception strength acquirer

46, 63 Display unit

42 Degradation determinator

43 Index value calculator

44 Warning output unit

45 Container management unit

1. A management device comprising:
a reception strength acquirer configured to acquire reception strengths of transmission signals transmitted by a plurality of transmission devices attached respectively to management targets when the transmission signals are received by a plurality of reading devices; and
a degradation determinator configured to determine, on a basis of a result of comparison between an index value based on a plurality of reception strengths acquired in a predetermined period and a newly acquired reception strength, whether or not one of the plurality of reading devices that has received a transmission signal corresponding to the newly acquired reception strength has degraded.

2. The management device according to claim 1, wherein the index value is calculated for each of the plurality of transmission devices on a basis of a plurality of reception strengths acquired in the predetermined period, and
the degradation determinator is further configured to determine whether or not the one of the plurality of reading devices that has received a transmission signal corresponding to the newly acquired reception strength has degraded on a basis of a result of comparison between the index value for one of the plurality of transmission devices that has transmitted the transmission signal corresponding to the newly acquired reception strength and the newly acquired reception strength.

3. The management device according to claim 1, wherein the index value is calculated for each of the plurality of reading devices on a basis of a plurality of reception strengths acquired in the predetermined period, and
the degradation determinator is further configured to determine whether or not the one of the plurality of reading devices that has received a transmission signal corresponding to the newly acquired reception strength has degraded on a basis of a result of comparison between the index value for the one of the plurality of reading devices that has received the transmission signal corresponding to the newly acquired reception strength and the newly acquired reception strength.

4. The management device according to claim 1, wherein the index value is calculated from the plurality of reception strengths acquired in the predetermined period.

5. The management device according to claim 1, wherein the degradation determinator is further configured to determine that the one of the plurality of reading devices has degraded when the newly acquired reception strength is smaller than the index value.

6. The management device according to claim 1, further comprising an index value calculator configured to acquire a highest reception strength among reception strengths greater than or equal to a threshold value serving as a reference for performing degradation determination of the plurality of reading devices in the predetermined period and to calculate the index value on a basis of the acquired reception strength.

7. A reading device management method comprising:
acquiring reception strengths of transmission signals transmitted by a plurality of transmission devices attached respectively to management targets when the transmission signals are received by a plurality of reading devices; and
determining, on a basis of a result of comparison between an index value based on a plurality of reception strengths acquired in a predetermined period and a newly acquired reception strength, whether or not one of the plurality of reading devices that has received a transmission signal corresponding to the newly acquired reception strength has degraded.

8. A non-transitory computer-readable medium having a program causing a computer for a management device to function as:
a reception strength acquisition means that acquires reception strengths of transmission signals transmitted by a plurality of transmission devices attached respectively to management targets when the transmission signals are received by a plurality of reading devices; and
a degradation determination means that determines, on a basis of a result of comparison between an index value based on a plurality of reception strengths acquired in a predetermined period and a newly acquired reception strength, whether or not one of the plurality of reading devices that has received a transmission signal corresponding to the newly acquired reception strength has degraded.
